(19) United States
(12) Patent Application Publication
(10) Pub. No.: US 2013/0227087 A1
(43) Pub. Date: Aug. 29, 2013

(54) MOBILE TERMINAL AND METHOD FOR CONTROLLING SAME

(71) Applicants: Seungyong Park, Seoul (KR); Woosik Choi, Seoul (KR)

(72) Inventors: Seungyong Park, Seoul (KR); Woosik Choi, Seoul (KR)

(73) Assignee: LG ELECTRONICS INC., Seoul (KR)

(21) Appl. No.: 13/820,444

(22) PCT Filed: Sep. 2, 2010
(86) PCT No.: PCT/KR10/05985

§ 371 Date: May 13, 2013

(51) Int. Cl. H04W 4/18

(52) U.S. Cl. CPC H04W 4/18
USPC 709/219

(57) ABSTRACT

A mobile terminal and a control method thereof are disclosed. The mobile terminal includes a wireless communication unit, an input unit, and a controller for acquiring a user input for generating content through the input unit, changing the format of the generated content into formats respectively corresponding to a plurality of servers to which the generated content will be transmitted upon acquisition of a signal for selecting the plurality of servers, and transmitting the content in the changed formats to the plurality of servers through the wireless communication unit. Accordingly, a user can generate content without considering characteristics of the plurality of servers, improving user convenience.

### TECHNICAL FIELD

The present invention relates to a mobile terminal and a control method thereof, and more particularly, to a mobile terminal and a control method thereof, by which a user can generate content without considering characteristics of a plurality of servers, improving convenience.

### DISCUSSION OF THE RELATED ART

As functions of terminals such as personal computers, laptop computers, cellular phones diversify, the terminals become multimedia players having multiple functions for capturing pictures or moving images, playing music, moving image files and games and receiving broadcasting programs.

Terminals can be categorized as mobile terminals and stationary terminals. The mobile terminals can be further comprised of handheld terminals and vehicle mount terminals according to whether users can personally carry the terminals. Conventional terminals including mobile terminals provide an increasing number of complex and various functions.

To support and enhance the increasing number of functions in a terminal, improving a structural part and/or a software part of the terminal would be desirable.

As various terminals including a mobile terminal provide a variety of complicated functions, menu structures also become complicated. Furthermore, a function of displaying digital documents including web pages through a terminal is added.

### SUMMARY

An object of the present invention is to provide a mobile terminal and a control method thereof, by which a user can generate content without considering characteristics of a plurality of servers, improving convenience.

To achieve the object of the present invention, there is provided a mobile terminal including: a wireless communication unit; an input unit; and a controller for acquiring a user input for generating content through the input unit, changing the format of the generated content into formats respectively corresponding to a plurality of servers to which the generated content will be transmitted upon acquisition of a signal for selecting the plurality of servers, and transmitting the content in the changed formats to the plurality of servers through the wireless communication unit.

The plurality of servers may include a short message service (SMS) server, a multimedia message service (MMS) server, an email server and a social network service (SNS) server.

The plurality of servers may include first and second SNS servers providing different services.

The mobile terminal may further include a memory storing at least one of log-in information of the plurality of servers and content update characteristics of the plurality of servers.

The controller may change the format of the content into a plurality of formats on the basis of the content update characteristics of the plurality of servers.

The controller may change the format of the content such that the format-changed content includes a link corresponding to at least part of the content.

The content may include at least one of a text, an image, video and music, wherein the controller changes the format of the content by deleting at least part of data included in the content from among the text, image, video and music.

The content may include at least one of a text, an image, video and music, wherein the controller changes the format of the content by converting the format of at least part of data included in the content from among the text, image, video and music.

The controller may sequentially transmit the content in the changed formats to the plurality of servers.

The mobile terminal may further include a memory, wherein the user input for generating the content includes at least one of data stored in the memory and data input through the input unit.

To achieve the object of the present invention, there is provided a method of controlling a mobile terminal, including: acquiring an input signal for generating content from a user; acquiring a signal for selecting a plurality of servers to which the generated content will be transmitted; changing the format of the generated content to formats respectively corresponding to the selected servers; transmitting the content in the changed formats to the plurality of servers.

The method may further include receiving a signal for selecting an editor application for acquiring the user input signal before the acquiring of the user input signal.

The changing of the format of the content may include changing the format of the content by deleting at least part of data included in the content, from among text, image, video and music included in the content.

The changing of the format of the content may include changing the format of the content by converting the format of at least part of data included in the content, from among text, image, video and music included in the content.

The transmitting of the content may include acquiring log-in information about the plurality of servers, and logging in the plurality of servers on the basis of the acquired log-in information.

The method may further include storing the log-in information about the plurality of servers, acquired from the user, in a memory.

According to the mobile terminal and control method thereof of the present invention, a user can generate content without considering characteristics of a plurality of servers, improving convenience.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram of a mobile terminal according to an embodiment;

FIGS. 2 and 3 are front and rear perspective views of the mobile terminal shown in FIG. 1;

FIG. 4 is a flowchart illustrating an operation of the mobile terminal shown in FIG. 1;

FIG. 5 shows a screen displayed on the mobile terminal according to the operation illustrated in FIG. 4;

FIG. 6 is a flowchart illustrating information exchange between the mobile terminal shown in FIG. 1 and external servers;

FIG. 7 is a table showing information necessary according to external servers;

FIG. 8 illustrates states of content converted for different servers; and

FIG. 9 illustrates states of content converted for different servers.

### DETAILED DESCRIPTION

Arrangements and embodiments may now be described more fully with reference to the accompanying drawings, in which exemplary embodiments may be shown. Embodiments may, however, be embodied in many different forms and should not be construed as being limited to embodiments set forth herein; rather, embodiments may be provided so that this disclosure will be thorough and complete, and will fully convey the concept to those skilled in the art.

A mobile terminal may be described below with reference to the accompanying drawings. In the following description, suffixes “module” and “unit” may be given to components of the mobile terminal in consideration of only facilitation of description and do not have meanings or functions discriminated from each other.

The mobile terminal may include a cellular phone, a smart phone, a laptop computer, a digital broadcasting terminal, personal digital assistants (PDA), a portable multimedia player (PMP), a navigation system and/or so on.

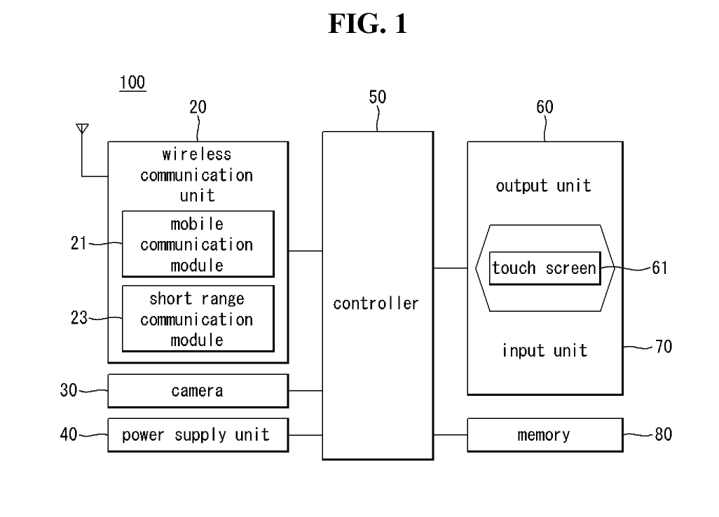

FIG. 1 is a block diagram of a mobile terminal according to an embodiment. Other embodiments, configurations and arrangements may also be provided.

A mobile terminal 100 according to an embodiment of the present invention may include a wireless communication unit 20, a camera 30, a memory 80, a controller 50, an output unit 60, and an input unit.

The wireless communication unit 20 may include at least one module that enables radio communication between the mobile terminal 100 and a radio communication system or between the mobile terminal 100 and a network in which the mobile terminal 100 is located. For example, the wireless communication unit 20 may include a mobile communication module 21 and a short range communication module 23 and may further include a wireless Internet module and a location information module (which are not shown).

The mobile communication module 21 transmits/receives a radio signal to/from at least one of a base station, an external terminal and a server in a mobile communication network. The radio signal may include an audio signal, a video call signal or various types of data according to text/multimedia message transmission/reception.

The short range communication module 23 may correspond to a module for short range communication. Bluetooth®, radio frequency identification (RFID), infrared data association (IrDA), ultra wideband (UWB) and/or ZigBee® may be used as a short range communication technique.

The camera 30 processes a video frame such as a still image or a moving image acquired by an image sensor in a video call mode or a photographing mode. The processed video frame may be displayed through the output unit 70. The video frame processed by the camera 50 may be stored in the memory or transmitted to the outside through the wireless communication unit 20. The mobile terminal 100 may include two or more cameras. For example, the mobile terminal 100 can include a first camera provided to the front side of the mobile terminal 100 and a second camera provided to the backside of the mobile terminal 100. The first camera may capture an image of the user of the mobile terminal 100 during video telephony and the second camera may capture an external image.

A power supply unit 40 may receive external power and internal power and supply power necessary for operations of components of the mobile terminal 100 under the control of the controller 50.

The controller 50 may control overall operations of the mobile terminal 100. For example, the controller 50 may perform control and processing for voice communication, data communication, video telephony, etc. The controller may also include a multimedia module for playing multimedia. The multimedia module may be included in the controller 50 or may be separated from the controller 50. The controller 50 may perform a pattern recognition process for recognizing handwriting input or picture-drawing input applied to a touch screen as characters or images.

The output unit may output information including a state of the mobile terminal 100 in various manners. While the output unit 60 is illustrated as a touch screen 61 in FIG. 1, the output unit 60 may include an audio output module, a haptic module, etc.

The input unit 70 may include a plurality of key buttons manipulated to receive commands for controlling operations of the mobile terminal 100. The key buttons may be called manipulating portions and may employ any tactile manner in which a user manipulates the key buttons while having tactile feeling. A display 61 illustrated as a component of the output unit 60 may also function as the input unit 70. For example, if the display 61 is a touch screen, a touch operation applied by the user to the display 61 can be acquired as an input to the mobile terminal 100.

The touch screen 61 can be regarded as the output unit 60 because it visually outputs information. Furthermore, the touch screen 61 can be regarded as the input unit 70 since it can receive a user input through a touch sensor included therein.

The memory 80 may store a program for operations of the controller 50 and temporarily store input/output data (e.g. a phone book, messages, still images, moving images, etc.). The memory 80 may also store data about vibrations and sounds in various patterns that are output when a touch input is applied to the touch screen. The memory 80 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The mobile terminal 100 may also operate in relation to a web storage that performs a storing function of the memory 80 on the Internet.

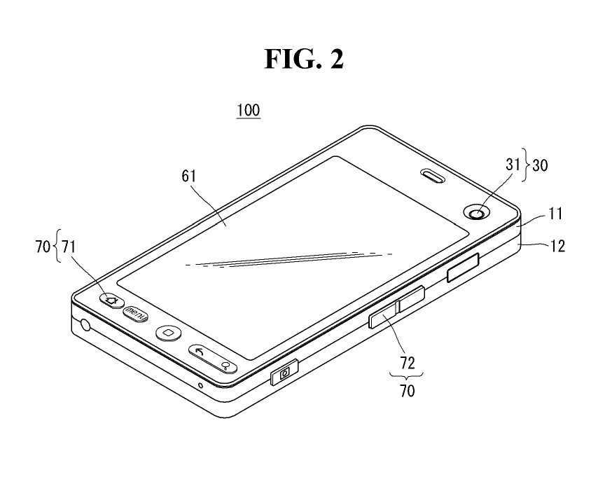

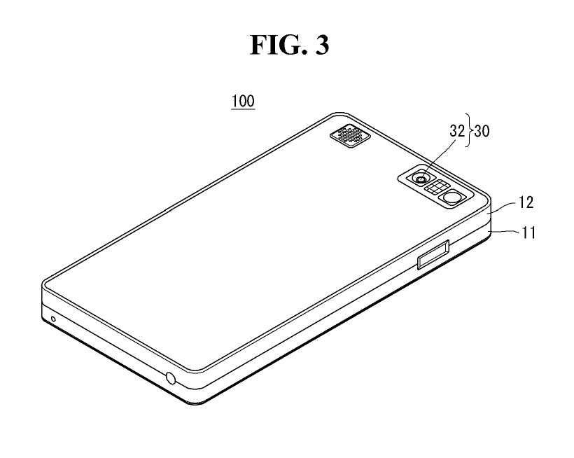

FIGS. 2 and 3 are front and rear perspective views of the mobile terminal shown in FIG. 1.

First and second bodies 11 and 12 can form the exterior of the mobile terminal 100. The first and second bodies 11 and 12 can be made by plastic injection molding. The exterior of the mobile terminal 100 can be formed in one body or formed by assembling two or more bodies. However, the front and rear bodies of the mobile terminal 100 are discriminated from each other as the first and second bodies 11 and 12 for easy understanding. The display 61 and a first camera 31 may be provided to the first body 11 and a second camera 32 may be provided to the second body 12.

The first and second bodies 11 and 12 may include a key pad 71 and a button 71 corresponding to the input unit 70.

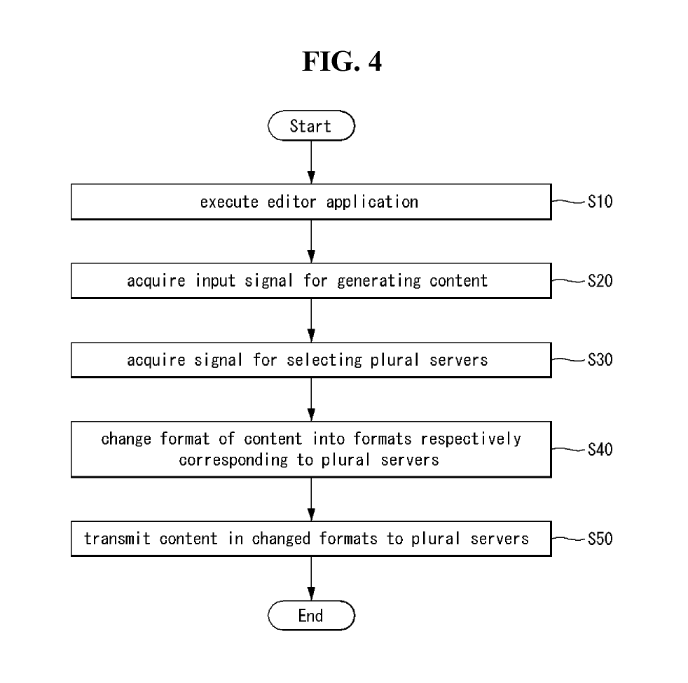

FIG. 4 is a flowchart illustrating an operation of the mobile terminal shown in FIG. 1.

Referring to FIG. 4, the controller (50 shown in FIG. 1) of the mobile terminal 100 according to an embodiment of the present invention may execute an editor application (S10).

The editor application may be an application capable of executing a function according to an embodiment of the present invention, from among applications executed in the mobile terminal 100.

The editor application can generate content according to a user input. Various types of content, for example, a text, an image, video, music, etc. can be generated according to user inputs. Furthermore, one content may include a text and an image, a text and video, or a text and music. A user can generate desired content using the editor application.

Upon execution of the editor application, an input signal for generating content may be acquired (S20).

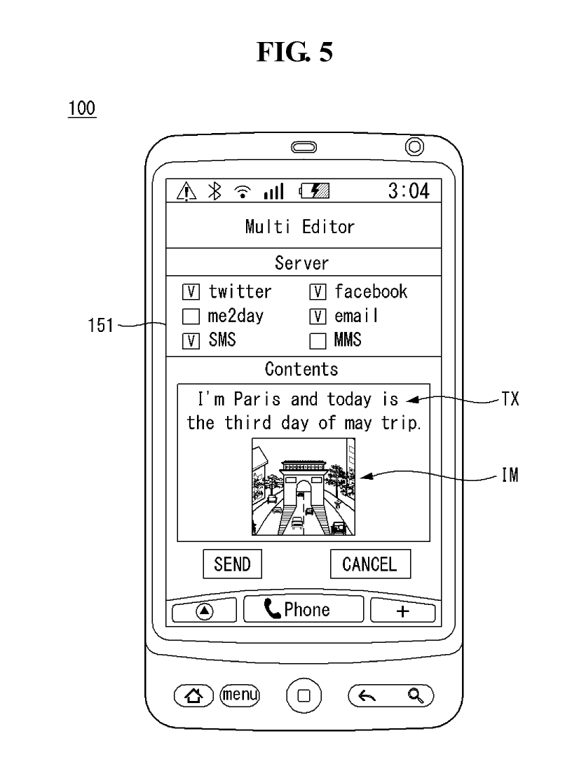

The user can generate content by manipulating the editor application. For example, the user can generate content by inputting a text TX and an image IM, as shown in FIG. 5. The input signal for generating the content may be generated by touching the touch screen 151. Furthermore, the user may generate content using the keypad 71 and button 72 provided to the first and second bodies 11 and 12 of the mobile terminal 100.

A signal for selecting a plurality of servers may be acquired (S30).

A server may be an external device that receives content data and performs a specific function. For example, the server may be a server providing a social network service (SNS). The SNS provides a service through which a user can easily exchange information with other registered users. The SNS may have different names according to service providers. For example, the SNS may have the names of twitter, facebook, me2day, etc.

A server may provide an email service, a short message service (SMS), or a multimedia message service (SMS). That is, when the user transmits content created using the mobile terminal 100 to a specific email server, the email server can send the content to a recipient.

The user can select a plurality of servers to which generated content will be delivered. For example, the user can select twitter, facebook, email and SMS, as shown in FIG. 5.

The format of content may be changed to formats respectively corresponding to the plurality of servers (S40).

A server may require a format optimized for the service provided thereby. That is, servers can have different content formats. For example, a specific. SNS can limit the number of characters of an uploaded text. Another SNS cannot upload video. Furthermore, a specific email server can limit the capacity of an attached file to a predetermined range.

The controller (50 shown in FIG. 1) of the mobile terminal 100 according to an embodiment of the present invention can change the format of the content such that the content is optimized for a server to which the content will be uploaded. For example, if a specific server cannot upload a video although content generated by the user includes a text and a video, content from which the video has been removed can be uploaded to the server. If a specific server can upload an image although it cannot upload a video, images corresponding to main parts of the video can be uploaded to the server.

The format may be changed such that the format corresponds to the plurality of servers selected by the user. Accordingly, the user need not edit the content such that the content is adapted for the respective servers. Inconvenience of editing the content to be suitable for the respective servers is expected to be considerable when the number of servers to which the content generated by the user will be uploaded increases.

Format change can be automatically performed under the control of the controller (50 shown in FIG. 1) when the plurality of servers selected by the user includes a server that requires content format change.

Format change may be performed in such a manner that part of data included in the content is removed or a data format is changed. For example, data of 500 bytes or more can be deleted or an image file format can be changed from JPEG to bitmap.

The content in changed formats may be transmitted to the plurality of servers (S50).

The controller (50 shown in FIG. 1) can transmit the content in the changed formats respectively corresponding to the servers to servers. The controller (50 shown in FIG. 1) can transmit the content in the changed formats using the wireless communication unit (20 shown in FIG. 1). The content in the changed formats may be sequentially transmitted. For example, content changed into a first format can be transmitted to an SNS server, and then content changed into a second format can be transmitted to another SNS server.

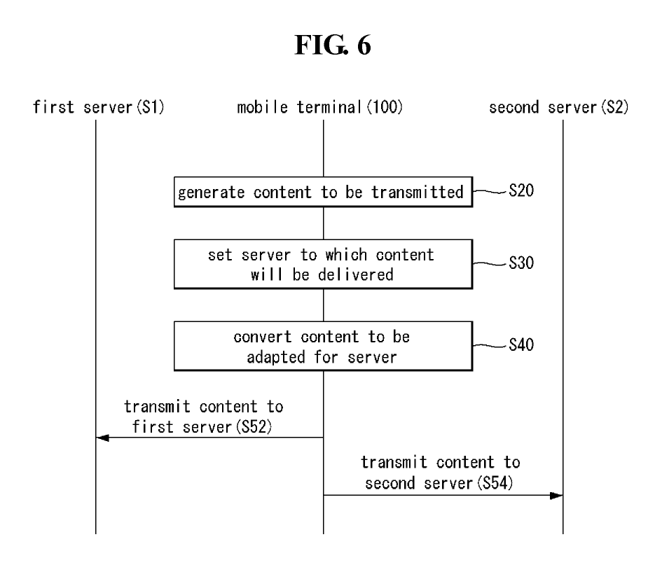

FIG. 6 is a flowchart illustrating information exchange between the mobile terminal shown in FIG. 1 and external servers.

Referring to FIG. 6, the mobile terminal 100 according to an embodiment of the present invention may generate content to be transmitted according to a user input (S20) and set servers to which the content will be transmitted (S30).

Then, the format of the content may be changed into formats suitable for the server (S40).

Content formats adapted for the servers to which the content will be sent may be stored in the memory (80 shown in FIG. 1) of the mobile terminal 100. The controller (50 shown in FIG. 1) can load a format stored in the memory (80 shown in FIG. 1) and change the content into the loaded format.

The content may be transmitted to a first server (S52).

The first server may be one of a plurality of servers selected by the user. To transmit the content to the first server, the user may log in the first server. For example, when the first server is a first SNS server, the user may need to log in the first SNS server in order to upload the content. The controller (50 shown in FIG. 1) can upload the content in a changed format suitable for the first server to the first server when the controller successfully logs in the first server.

The content may be transmitted to the second server (S54).

The second server may be one of the plurality of servers selected by the user. To transmit the content to the second server, the user may log in the second server. The controller (50 shown in FIG. 1) can upload the content in the changed format corresponding to the second server to the second server upon successful log-in.

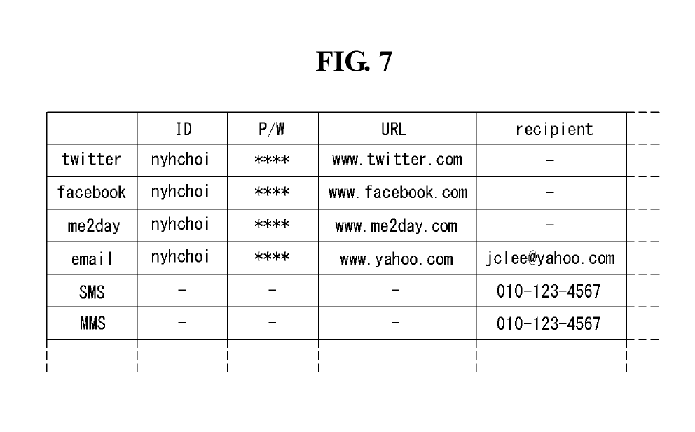

FIG. 7 shows information necessary according to external servers.

As shown in FIG. 7, different types of information may be stored in the memory (80 shown in FIG. 1) according to external server type.

To access twitter, a twitter ID and a password may be needed. Furthermore, the URL address of twitter may be required. If content is uploaded to twitter, information about a recipient may not be needed. Information necessary to upload content to twitter may include information regarding restriction on the number of characters, which is not shown in the table. For example, information regarding limitation of the number of characters to 140 may be included in the information necessary to upload content to twitter.

In order to access facebook, an ID, password and URL address may be needed, similarly to twitter. Furthermore, information regarding constraints with respect to facebook may be present.

To send email, an ID and a password may be needed. Furthermore, the URL of an email server may be required. In addition, information about a recipient may be needed. The recipient may be previously set or selected when email is sent. Constrains with respect to email may be recorded. For example, a constraint on the capacity of an attached file can be present for a specific server.

Information about a recipient may be needed in order to transmit a short message or a multimedia message to the recipient. Furthermore, constraints with respect to SMS or MMS may be recorded. For example, constraints on the number of characters included in a short message, inclusion of a video in a multimedia message, etc. may be recorded.

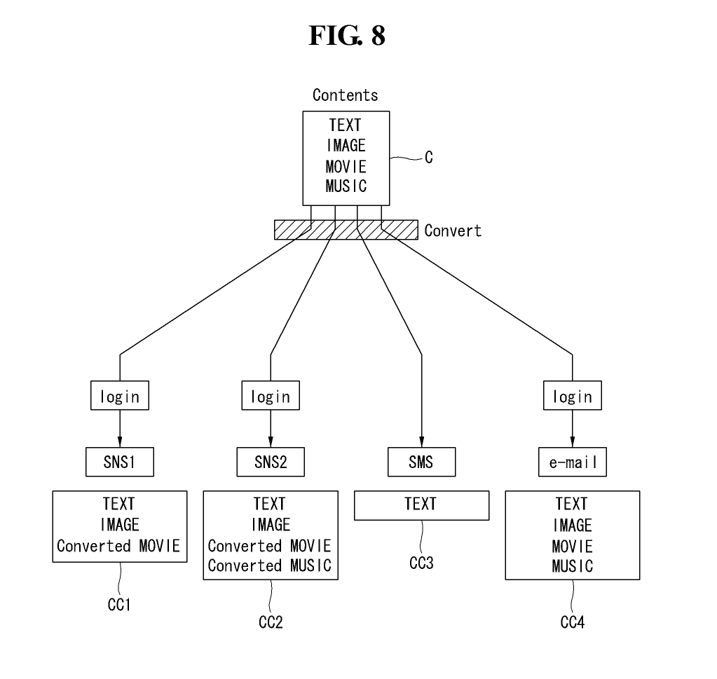

FIG. 8 shows states of content converted for different servers.

Referring to FIG. 8, the controller (50 shown in FIG. 1) of the mobile terminal (100 shown in FIG. 1) can convert content C input thereto and transmit the converted content to a plurality of servers.

The user can generate the content C that they want to transmit. The content C may be stored in the memory (80 shown in FIG. 1) of the mobile terminal (100 shown in FIG. 1) or input by the user in real time. For example, the content C can include an image, a video, music, etc. previously stored in the memory (80 shown in FIG. 1) by the user. Furthermore, the user can input a text to be included in the content C.

Upon generation of the content C, the user can select servers to which the content C will be transmitted. Upon selection of the servers, the controller (50 shown in FIG. 1) can convert the content C such that the content C is suitable for each server. The user can select first to fourth servers. The first and second servers may be first and second SNS servers, the third server may be an SMS server, and the fourth server may be an email server.

When The controller (50 shown in FIG. 1) can log in the first SNS server on the basis of log-in information stored in the memory (80 shown in FIG. 1). The log-in information may include an ID, password, URL, etc.

When the controller logs in the first server, the controller (50 shown in FIG. 1) can transmit first converted content CC1 to the first SNS server. Here, the first SNS server may be restricted from uploading a video according to size, definition, etc. while the first SNS server can upload a text and an image. Accordingly, the controller (50 shown in FIG. 1) can change the content C such that the content C is suitable for the characteristic of the first SNS server. That is, a video is converted and uploaded to the first SNS server while the text and image included in the content C input by the user are uploaded to the first SNS server without being converted.

The controller (50 shown in FIG. 1) can log in the second SNS server on the basis of the log-in information. Upon successful log-in, the controller (50 shown in FIG. 1) can upload second converted content CC2 that has been converted to be suitable for the second SNS server. For example, the second SNS server may be a server that needs conversion of video and music for upload.

The controller (50 shown in FIG. 1) can transmit the content C to the SMS server. Third converted content CC3 which has been converted for the SMS server may include only a text.

The controller (50 shown in FIG. 1) can transmit the content C to the email server. The controller (50 shown in FIG. 1) can log in the email server on the basis of the log-in information, and then transmit fourth converted content CC4 which has been converted to be suitable for the email server.

The controller (50 shown in FIG. 1) automatically converts the content C such that the content C is suitable for each server to which the content C will be transmitted, improving user convenience. That is, since the user need not process the content C such that the content C can be used by each server, the user can use the mobile terminal more conveniently.

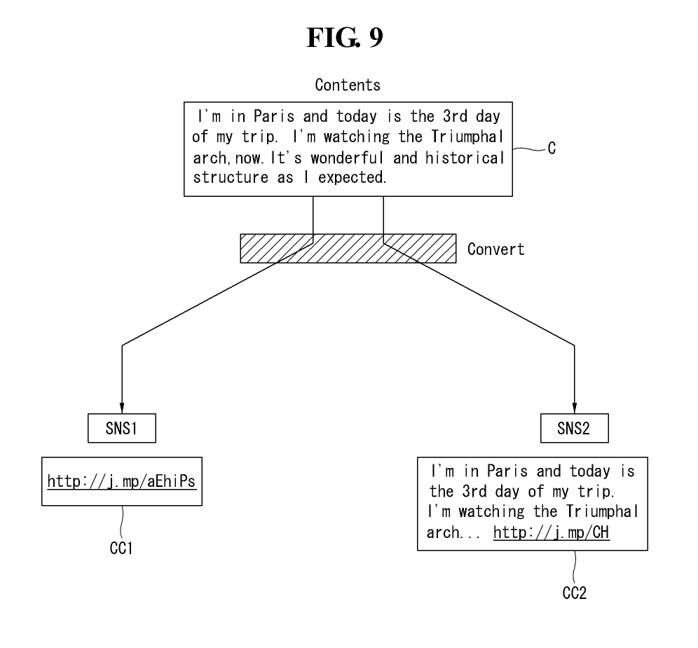

FIG. 9 shows states of content converted for different servers.

As shown in FIG. 9, the content C can be converted to correspond to various situations.

The content C may include only a text. That is, the content C can include two or more elements having different properties such as a text and an image or can be composed of only a specific element.

The content C including the text can be appropriately converted according to characteristics of a server to which the content C will be sent. It is assumed that the user selects the first and second SNS servers to which the content C will be delivered.

The first SNS server may be restricted from uploading a text. In this case, the controller (50 shown in FIG. 1) can replace the first converted content CC1 to be uploaded to the first SNS server by a link instead of a text. That is, the controller (50 shown in FIG. 1) can transmit a link through which the text input by the user can be viewed to the first SNS server rather than directly uploading the text to the first SNS server.

The second SNS server may restrict the capacity of an uploaded text while it can upload the text. In this case, the controller (50 shown in FIG. 1) can convert the content C into the second converted content CC2 such that the second converted content CC2 includes part of the text included in the content C and a link corresponding to the remaining part of the text. That is, the content C can be converted into the second converted content CC2 including a text and a link.

Content including only one element, such as a text, an image, video or music can also be converted to be suitable for a format corresponding to a server to which the content will be delivered, thereby improving user convenience.

The foregoing embodiments and features are merely exemplary in nature and are not to be construed as limiting the present invention.. The disclosed embodiments and features may be readily applied to other types of apparatuses. The description of the foregoing embodiments is intended to be illustrative, and not to limit the scope of the claims. Many alternatives, modifications, and variations will be apparent to those skilled in the art.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal, comprising:
a wireless communication unit;
an input unit; and
a controller configured to;
acquire a user input for generating content through the input unit,
change the format of the generated content into formats respectively corresponding to a plurality of servers to which the generated content will be transmitted upon acquisition of a signal for selecting the plurality of servers, and
transmit the content in the changed formats to the plurality of servers through the wireless communication unit.

2. The mobile terminal of claim 1, wherein the plurality of servers includes a short message service (SMS) server, a multimedia message service (MMS) server, an email server and a social network service (SNS) server.

3. The mobile terminal of claim 1, wherein the plurality of servers includes first and second SNS servers providing different services.

4. The mobile terminal of claim 1, further comprising a memory configured to store at least one of log-in information of the plurality of servers and content update characteristics of the plurality of servers.

5. The mobile terminal of claim 4, wherein the controller is configured to change the format of the content into a plurality of formats on the basis of the content update characteristics of the plurality of servers.

6. The mobile terminal of claim 1, wherein the controller is configured to change the format of the content such that the format-changed content includes a link corresponding to at least part of the content.

7. The mobile terminal of claim 1, wherein the content includes at least one of a text, an image, video and music,
wherein the controller changes the format of the content by deleting at least part of data included in the content from among the text, image, video and music.

8. The mobile terminal of claim 1, wherein the content includes at least one of a text, an image, video and music,
wherein the controller is configured to change the format of the content by converting the format of at least part of data included in the content from among the text, image, video and music.

9. The mobile terminal of claim 1, wherein the controller is configured to sequentially transmit the content in the changed formats to the plurality of servers.

10. The mobile terminal of claim 1, further comprising a memory,
wherein the user input for generating the content includes at least one of data stored in the memory and data input through the input unit.

11. A method for controlling a mobile terminal, comprising:
acquiring an input signal for generating content from a user;
acquiring a signal for selecting a plurality of servers to which the generated content will be transmitted;
changing the format of the generated content to formats respectively corresponding to the selected servers;
transmitting the content in the changed formats to the plurality of servers.

12. The method of claim 11, further comprising receiving a signal for selecting an editor application for acquiring the user input signal before the acquiring of the user input signal.

13. The method of claim 11, wherein the changing of the format of the content comprises changing the format of the content by deleting at least part of data included in the content, from among text, image, video and music included in the content.

14. The method of claim 11, wherein the changing of the format of the content comprises changing the format of the content by converting the format of at least part of data included in the content, from among text, image, video and music included in the content.

15. The method of claim 10, wherein the transmitting of the content comprises:
acquiring log-in information about the plurality of servers; and
logging in the plurality of servers on the basis of the acquired log-in information.

16. The method of claim 10, further comprising storing the log-in information about the plurality of servers, acquired from the user, in a memory.
